(19) United States
(12) Patent Application Publication
(10) Pub. No.: US 2025/0021882 A1
(43) Pub. Date: Jan. 16, 2025

(54) GENERATING EFFECTIVE REPRESENTATIONS

(71) Applicant: Texture Al Limited, London (GB)

(72) Inventors: James Patrick Carney, Oxford (GB); Cole Byron John Robertson, Oxford (GB)

(21) Appl. No.: 18/770,201

(22) Filed: Jul. 11, 2024

(30) Foreign Application Priority Data
Jul. 11, 2023 (GB) 2310635.4

(51) Int. Cl. G06N 20/00

(52) U.S. Cl. CPC G06N 20/00

(57) ABSTRACT

A system for generating effective representations and for providing a quantitative indication of the effectiveness of different portions of the representations. The system includes: a user input for inputting a user desired property for a representation; machine learning circuitry trained with a data set of representations and indications of effectiveness relative to different properties, the machine learning circuitry being configured to provide predicted effectiveness scores that indicate effectiveness relative to the desired property; analysing circuitry configured to analyse of the data set of representations to determine a contribution to the predicted effectiveness scores arising from the components. Generative machine learning circuitry may be used with the set of representations, the predicted effectiveness scores and the component contributions to generate a candidate set of representations. The system is configured to transmit the generated candidate set of representations to the trained machine learning circuitry and then to the analysing circuitry; the trained machine learning circuitry predicting effectiveness relative to the desired at least one property for the candidate set of representations and the analysing circuitry analysing components of the candidate set of representations to determine a contribution to the predicted effectiveness scores arising from the components for at least some of the representations in the set of representations. The system further has a display for outputting the candidate set of representations processed by the trained machine learning circuitry and the analysing circuitry along with an indication of predicted effectiveness and of contributions of different components to the predicted effectiveness determined by the trained machine learning circuitry and the analysing circuitry.

### CROSS-REFERENCE TO RELATED CASES

This application claims the benefit of GB Application No. 2310635.4 filed Jul. 11, 2023 herein incorporated by reference in its entirety for all purposes.

### FIELD OF THE INVENTION

The field of invention relates to generating representations and to generating a quantitative indication of their predicted effectiveness.

### BACKGROUND OF THE INVENTION

Representations such as images or words may be used to provide information. Some ways of providing the information are more effective and result in greater user engagement. Where the information is provided via an interactive apparatus the user engagement may be quantified and if sufficient data is collected a statistical analysis performed to relate the type of representation to the type of engagement.

Machine learning may be used both to determine the effectiveness of the representations and to generate representations that the machine learning predicts to be effective. However, although such techniques are known and may generate effective representations, they may also generate representations that are less effective, and as these techniques are becoming increasingly opaque, it is difficult for a user to gauge the applicability of the generated representations and to consistently select effective representations.

It would be desirable to be able consistently to select or generate effective representations.

### SUMMARY OF THE INVENTION

A first aspect provides a method of providing candidate representations and quantitative indications of the effectiveness of said candidate representations, said method comprising: training a machine learning model with a data set of representations and indications of effectiveness relative to different properties; receiving an indication of at least one desired property; using said trained machine learning model, to provide predicted effectiveness scores that indicate effectiveness relative to said at least one desired property for at least some of said data set of representations; analysing components of said at least some of said data set of representations to determine a contribution to said predicted effectiveness scores arising from at least one of said components; outputting said set of representations, said predicted effectiveness scores and said component contributions; receiving a candidate set of representations; and using said trained machine learning model to predict effectiveness relative to said at least one desired property for said candidate set of representations; analysing components of said candidate set of representations to determine a contribution to said predicted effectiveness scores arising from at least one of said components for at least some of said representations in said set of candidate representations; and outputting at least some of said candidate set of representations along with an indication of predicted effectiveness and of contributions of different components to said predicted effectiveness.

It was recognised that data is increasingly available that provides a quantitative indication of user engagement when a user is viewing representations of information on an interactive device such as a computer, tablet or mobile phone. Such data may be used to train a machine learning model. A desired property may then be input to the model and the representations and their predicted effectiveness relative to the property may be found. A statistical analysis of components of the representations may be made to determine the contribution to the effectiveness of different components. In this way not only can the more effective representations for a particular property be isolated or filtered from a large data set, but a quantitative indication of the contributions of different components can also be determined.

This information may be output to a user who may use a generative machine learning model to generate a candidate set of representations, which may in turn be fed back to the trained machine learning model and the analysis tool to determine the predicted effectiveness and contributions of different components of the generated candidate representations. This allows not only representations with desired properties to be generated but also an indication as to their predicted effectiveness and what components of the representation may contribute a higher or lower amount to this to be provided.

This information may then be output again to a user.

By providing representations along with an indication not only of their effectiveness but also of the contribution to that effectiveness of individual components of the representations, both a basis for improving the representations and also for understanding why the representation might have been considered to be effective is provided. This allows a user to have a better understanding and increased confidence in the candidate representations. Machine learning tools are increasingly opaque and embodiments provide not only a relevant subset of data selected from a large data set to a user but also an indication as to its effectiveness. Providing a quantitative indication of the effectiveness or relevance of different components enables a user to determine whether the model is functioning well and whether the representations are effective and relevant. In this way a user is provided with a filtered data set and in some cases an improved data set along with an indication of the value of different components, allowing the user to generate and select one or more representations. These will be representations that are predicted to be more effective and that therefore when used will need to be output and displayed fewer times to generate the same user engagement property compared to other representations, thereby reducing processing time, bandwidth used and power consumption for the same result.

The desired property may be indicated by the user and may be a performance metric for which there is a quantitative indication. This may include such things as: number of interactions, click-through rate, app download numbers, web site visits, likes, purchases etc.

The representations are a means of providing information and may include images, video, words, sounds etc.

In some embodiments, said step of analysing said components comprises statistically analysing said components using correlation data that correlates contributions to effectiveness of different components of representations with respect to desired properties.

In some embodiments, said analysing step comprises generating said correlation data by inputting a data set of representations and associated effectiveness scores to a machine learning model to train the model to identify a quantitative contribution of different components of the representations to the effectiveness score for different desired properties.

In some embodiments, said different components comprise at least one of colours, images, words, video, sounds.

In some embodiments, said step of analysing comprises identifying the components that contribute to lowering the effectiveness score and those that contribute to raising the effectiveness score for a property.

The different components of a representation's contribution to the effectiveness score are analysed and those components that have a particular effect at either lowering or increasing the effectiveness may be identified and in some embodiments later displayed to a user in conjunction with the representation.

In some embodiments, said step of training said machine learning model comprises supplying said machine learning model with a data set providing a quantitative indication of a contribution of different components of a representation to a particular class of attribute, and said step of analysing components of said at least some of said data set of representations comprises determining a quantitative contribution to a particular class of attribute of different components of said representation.

In addition to providing an indication of the predicted effectiveness of different components, the model may also provide a quantitative indication of a contribution to a particular class of attribute. These attributes may comprise linguistic measures that relate to different cognitive and emotional responses of a user, and different components may be indicated as providing a strong or weak contribution to a particular attribute. In this way further details of the predicted effectiveness may be provided to a user, helping a user select a particularly effective representation for a particular purpose. Thereby allowing the representation to have increased user engagement and be displayed fewer times for a same result.

In some embodiments, said step of outputting comprises outputting said candidate representations with higher predicted effectiveness scores.

Outputting the candidate representations with higher predicted effectiveness scores is a way of filtering the generated content such that the user has only to view a reduced amount of data, that reduced amount of data being that predicted to be most useful.

In some embodiments, said step of outputting comprises outputting indications of a contribution to said quantitative effectiveness score of at least some components of said output candidate representations.

In some embodiments, said step of outputting comprises outputting said candidate representations with indications of components that are lower scoring.

As well as outputting the candidate representations that are predicted to be the most effective, portions of these representations that detract from the effectiveness may also be identified making it easy for a user to manipulate and change the representations to provide improved representations.

In some embodiments, said step of outputting comprises outputting proposals for replacement of said lower scoring components with higher scoring components.

In addition to identifying the lower scoring components, potential higher scoring replacements may be suggested further aiding the user in increasing the effectiveness of a generated representation.

A second aspect provides a method of generating effective representations and of providing a quantitative indication of the effectiveness of different portions of said representations, said method comprising: receiving a set of representations, predicted effectiveness scores and component contributions from a trained machine learning model; inputting said set of representations to a generative machine learning model; receiving a candidate set of representations from said generative machine learning model; outputting said candidate set of representations to said trained machine learning model; and receiving said candidate set of representations along with an indication of predicted effectiveness and of contributions of different components to said predicted effectiveness from said trained machine learning model; and displaying at least some of said candidate set of representations and indications of effectiveness.

The output from a machine learning model that has been trained with a data set of representations and associated effectiveness indications, which data set may have been supplied by a user, may be used by the user to provide input data for a generative machine learning model that can then generate a candidate set of representations from the data set and the indications of effectiveness. This candidate set of representations may be passed back through the trained machine learning model and the analysis circuitry and the representations, their effectiveness and the contribution of different portions of the representations to the effectiveness may be generated and displayed to a user.

In some embodiments, said step of displaying at least some of said received candidate set of representations comprises displaying said candidate representations with higher predicted effectiveness scores.

In some embodiments, said step of displaying at least some of said candidate set of representations comprises displaying said at least some of said candidate representations along with indications indicating components within said representations that are lower scoring components.

In some embodiments, said step of receiving and displaying at least some of said candidate set of representations comprises receiving and displaying proposals for replacement of said lower scoring components with higher scoring components.

In some embodiments, said method further comprises a step of receiving a user input indicating at least one preferred replacement higher scoring component; and replacing at least one of said lower scoring components with said selected at least one higher scoring component and displaying an updated candidate representation.

The step of generating representations may include selecting an effective representation from the data set and/or combining different portions of different representations to generate new more relevant representations. The improvement of the generated candidate representations may be performed in conjunction with a user input, the user receiving indications of possible amendments and their predicted effect and selecting the desired amendments to make in response thereto.

In some embodiments, said method comprising an initial step of requesting a user to input a user desired property and outputting said user desired property to said trained machine learning model.

In some embodiments, said step of using said machine learning model to generate said candidate set of representations comprises analysing the predicted effectiveness of components of at least some of said representations and generating representations from a combination of different components contributing to a higher predicted effectiveness.

In some embodiments, said representations comprise advertisements or public safety or health information and said effectiveness comprises an estimate of user engagement.

In some embodiments, said method further comprises distributing the selected representation to users via the Internet.

By distributing representations that are deemed to be more effective, fewer of the representations need to be distributed or output for the same amount of user engagement, thereby saving power and bandwidth. In some cases this may mean distributing them for a shorter amount of time, and/or on fewer sites.

In some embodiments, said method comprises a method of providing candidate representations and predicted effectiveness according to a first aspect and a method of generating effective representations from said candidate representations according to a second aspect.

A third aspect provides a computer program comprising computer executable instructions which when executed by a computer are operable to control said computer to perform a method according to any one of a first or second aspect.

A fourth aspect provides a system for providing candidate representations and of providing a quantitative indication of the effectiveness of said candidate representations, said system comprising: an input configured to receive an indication of at least one desired property for a representation; machine learning circuitry trained with a data set of representations and indications of effectiveness relative to different properties, said machine learning circuitry being configured to provide predicted effectiveness scores that indicate effectiveness relative to said at least one desired property for at least some of said data set of representations; analysing circuitry configured to analyse at least some of said data set of representations, to determine a contribution to said predicted effectiveness scores arising from at least one of said components; an output for outputting at least some of said set of representations, said predicted effectiveness scores and said component contributions; an input for receiving a candidate set of representations and for transmitting said candidate set of representations to said trained machine learning model and then to said analysing circuitry; wherein said trained machine learning model and analysing circuitry are configured to predict effectiveness relative to said at least one desired property for said candidate set of representations and for components of said candidate set of representations; and an output for outputting said candidate set of representations processed by said trained machine learning circuitry and said analysing circuitry along with an indication of predicted effectiveness and of contributions of different components to said predicted effectiveness determined by said trained machine learning circuitry and said analysing circuitry.

In some embodiments, said analysing circuitry is configured to statistically analyse said components using correlation data that correlates contributions to effectiveness of different components of representations with respect to desired properties.

In some embodiments, said analysing circuitry is configured to identify the components that contribute to lower and raise the effectiveness scores for that property.

In some embodiments, said machine learning model is trained by supplying said machine learning model with a data set providing a quantitative indication of a contribution of different components of a representation to a particular class of attribute, and analysing circuitry is configured to analyse components of said at least some of said data set of representations by determining a quantitative contribution to a particular class of attribute of different components of said representation.

The class of attributes may comprise linguistic measures, where words or phrases are classed as providing one or more particular cognitive or emotional reactions, the reactions being the different linguistic measures. This may help a user with the analysis of candidate representations as they may see the impact of particular words on particular reactions.

In some embodiments, said output for outputting at least some of said set of representations is configured to output said predicted effectiveness scores and said component contributions is configured to transmit the predicted effectiveness scores and representations to a generative machine learning model to generate said candidate set of representations and associated effectiveness indicators.

In some embodiments, said analysing circuitry is configured to statistically analyse said components using correlation data that correlates contributions to effectiveness of different components of representations with respect to desired properties.

In some embodiments, said analysing circuitry is configured to identify the components that contribute to lower and raise the effectiveness scores for that property.

A fifth aspect provides a system for generating effective representations and providing a quantitative indication of the effectiveness of different portions of said representations, said system comprising: an input configured to receive a set of representations, predicted effectiveness scores and component contributions from a trained machine learning model; an output configured to output said set of representations to a generative machine learning model; an input configured to receive a candidate set of representations from said generative machine learning model; an output configured to output said candidate set of representations to said trained machine learning model; and an input configured to receive said candidate set of representations along with an indication of predicted effectiveness and of contributions of different components to said predicted effectiveness from said trained machine learning model; and a display configured to display at least some of said candidate set of representations and indications of effectiveness.

In some embodiments, said display is configured to display said candidate representations with higher predicted effectiveness scores.

In some embodiments, said display is configured to output said candidate representations with indications of components that are lower scoring.

In some embodiments, said display is configured to output proposals for replacement of said lower scoring components with higher scoring components.

In some embodiments, said system comprises circuitry configured in response to receipt of a user input indicating at least one preferred replacement higher scoring component, to replace at least one of said lower scoring components with said selected at least one higher scoring component.

In some embodiments, said generative machine learning circuitry is configured to analyse the predicted effectiveness of components of at least some of said representations and generate representations from a combination of different components contributing to a higher predicted effectiveness.

In some embodiments, said display is configured to output said candidate representations with indications of components that are lower scoring.

In some embodiments, said display is configured to output proposals for replacement of said lower scoring components with higher scoring components.

In some embodiments, said system comprises circuitry configured in response to receipt of a user input indicating at least one preferred replacement higher scoring component, to replace at least one of said lower scoring components with said selected at least one higher scoring component.

In some embodiments, said input is configured to receive proposals for replacement of said lower scoring components with higher scoring components; and said display is configured to display said proposals.

In some embodiments there is provided a system for generating candidate representations according to a fourth aspect and a system of generating effective representations from said candidate representations according to a fifth aspect.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function. it will be appreciated that this includes an apparatus feature which provides that function or which is adapted or configured to provide that function.

### BRIEF DESCRIPTION OF THE DRAWINGS

Embodiments of the present invention will now be described further, with reference to the accompanying drawings, in which:

FIG. 1 schematically shows the interactions of different portions of the system when performing a method according to an embodiment;

FIG. 2 schematically shows the contributions of different words to particular linguistic measures;

FIG. 3 schematically shows a flow diagram illustrating steps in a method according to an embodiment;

FIG. 4 shows a flow diagram illustrating steps performed in a method to provide an indication of predicted effectiveness of different representations and of different components of the representations;

FIG. 5 shows a flow diagram illustrating steps of a method performed by a user generating candidate representations; and

FIG. 6 shows an apparatus or system according to an embodiment.

### DETAILED DESCRIPTION OF THE PREFERRED EMBODIMENTS

Embodiments relate to a system that uses Artificial Intelligence (AI) to help users more efficiently create effective representations such as may be used for advertising. In addition to generating effective representations a quantitative indication of the contribution of different components of the representation to the effectiveness are provided allowing a user to judge the effectiveness of the candidate representation and also to have an indication of how improvements may be made.

Embodiments may combine generative AI, predictive modelling, Explainable AI (XAI), and proprietary linguistic data. Explainable AI is a general term for a number of methods which allow humans to “see” inside black-box machine-learning models; for example, class-discriminating features of a text-classification algorithm might be derived from an unintelligible model and presented in understandable forms to users. Generative AI refers to a class of deep neural networks which can ingest high-level instructions and generate corresponding textual, or audio outputs.

Though predictive modelling is an established practice in the analysis and generation of representations in fields such as advertising, this has not previously been combined with explainable and generative AI to create a product that allows users to iteratively improve representations by selecting the subset of predicted high-performance representations in such a way as described below.

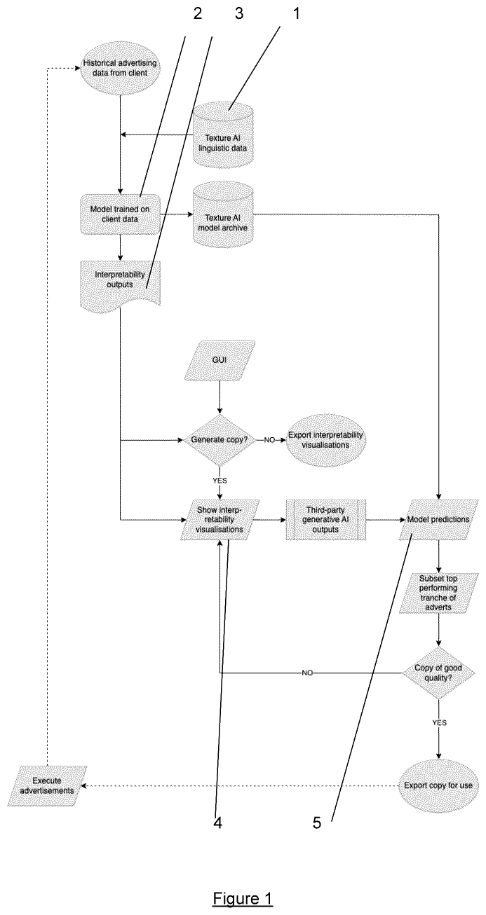

FIG. 1 provides a schematic illustration of how the system of an embodiment works, the figure illustrating the interaction of different functional components:
(1) a dataset of 19 linguistic measures may be used to translate a client-supplied dataset of historically served graphical and textual advertisements into quantitative forms appropriate for modelling by;
(2) a predictive model is trained on user data to predict a user-defined performance metric (click through rate, downloads, etc.) on the basis of graphical and textual representations of advertisements and in some embodiments the 19 metrics (1);
(3) XAI models are trained to derive class-discriminating features from (2), and interpretable features, that is the contribution to effectiveness of different components of the representations of the user data and are passed to;
(4) generative AI model which generates new graphical and textual representations based on features predicted to improve performance;
(5) these are passed back to the predictive model (2) which allows users to select the top tranche of predicted high-performing graphical or textual representations; finally,
(6) a graphical user interface (GUI) outputs a subset of the top performing representations and allows the user to interact with the product in an intuitive manner and which generates visualisations of the data presented.

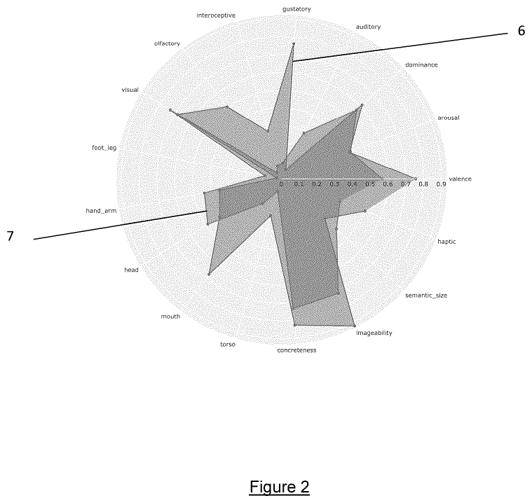

Looking in more detail at the individual components.
1—In this example the dataset of 19 linguistic measures provides cognitive and emotional response data on over a million words and word textual tokens. This includes (for example) how positive or exciting a word is felt to be, the extent to which it is associated with sense or part of the body, and how easy it is to conjure up a mental image of the word. This dataset helps explain the outputs of the predictive model. FIG. 2 schematically shows how two different words chocolate (shown in brown 6) and iphone (shown in blue 7) contribute to the different cognitive and emotional responses of a user, the 19 linguistic measures being shown around the outer edge of the circle.
2—A predictive model: The core of the system is a deep learning model that is trained on user-supplied data. This may use a transformer architecture to learn the linguistic features that predict high or low impact in each representation with maybe an item of advertising. This predictive model is calibrated to high levels of accuracy (contingent on data availability) and in some embodiments will output a binary score of HIGH and LOW probability of a representation being effective, according to a user-defined performance metric. The models may be proprietary or open source, but once trained will all be proprietary. The model will depend on the data that it is trained on as each user will have different data, each user will be using a different model. The term ‘model’ here may encompass a library of user-specific models, trained on user-defined tranches of relevant data.
3—An interpretability algorithm: Though deep learning models are highly effective at prediction, they are black boxes and it can be difficult to say why they make their predictions. This is problematic when it comes to selecting preferred and optimising representations, because improvements cannot be made without knowing what to improve. The interpretability algorithm addresses this problem by conducting statistical analyses of how the presence or absence of specific words, graphical features, or text metrics (i.e. [1]) affects the predictive model outputs. In the first instance, this allows each word, pixel, or metric to be assigned a weighting that quantifies its contribution to strong or poor performance. One way of achieving this is by training a simpler model (like a linear regression) on the outputs of the predictive model. The coefficients of this simpler model can then be interpreted as a measure of the importance of a feature's presence for the likelihood of success, allowing that interpretability comes at the expense of predictive accuracy (i.e. a regression cannot emulate a deep learning predictive model with perfect fidelity).
4—API (application programming interface) integration with generative AI: Large generative AI models are prohibitively expensive to train from scratch, so embodiments may make use of third-party API integration with an existing service. Copywriting, and graphical image generation is an established use case of generative AI models and well-supported by existing providers. The function of the integration will be to allow users to generate improved representations such as advertising copy. The user will do this by requesting the generative AI to draft new copy that explicitly incorporates the graphical and textual features identified as having a positive impact by the interpretability algorithm.
5—Predictive subsetting: After the user receives the new set of generated graphical and/or textual representations from (4), these are passed back to the predictive model (2) to get a new indication of predicted performance. This allows the user to select the top tranche of generated graphical and textual representations predicted to be high-performing.
6—Intuitive GUI: The user of the system is not expected to be proficient in coding and data science. The GUI will provide an easy-to-use interface that integrates the models that may be cloud-based models and data to the third party API. It will also provide data visualisations, log-in functionality, and user history features.

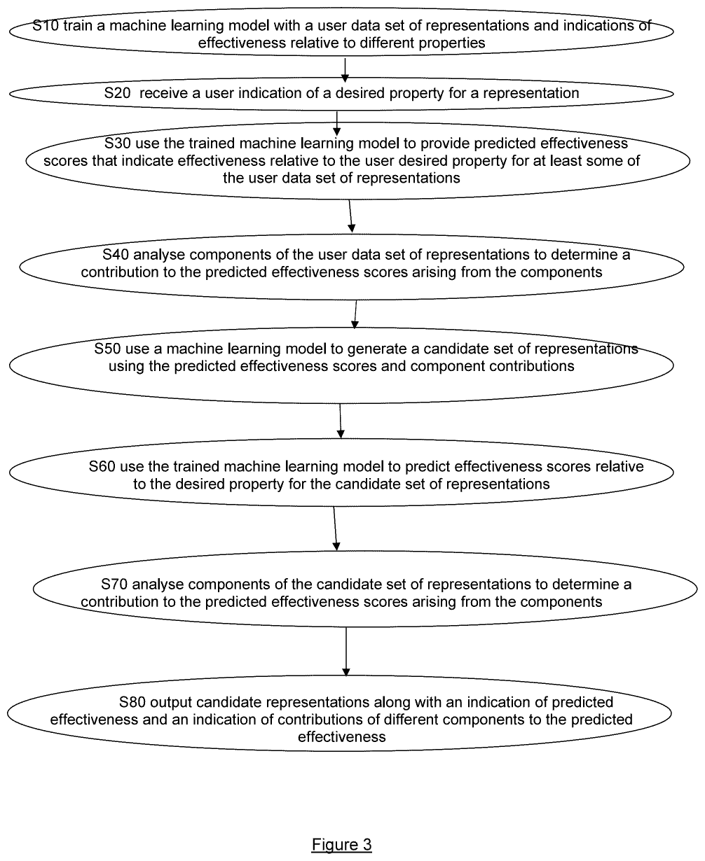

FIG. 3 shows a flow diagram illustrating steps in a method according to an embodiment. In an initial step S10 a machine learning model or algorithm is trained with a user data set of representations and indications of the effectiveness of these representations relative to different properties. This training data set may be a set of representations in the field desired, along with quantitative indications for each representation of user engagement for example. Thus, if a representation that is required is an advert for a particular device, then the training set may be a set of adverts for similar devices and quantitative data indicative of how each advert fared in user engagement, thus, there may be measures of click-through rate, web site visits, likes etc. If the representation is say a tweet, then the training data may be tweets in that area, and the quantitative measure may be shares, likes or something similar. If the representation is a video then the quantitative measure may be number of views and time spent viewing for example. If the representation is part of an interactive public information campaign, then the number of interactions with the representations may be measured.

In some cases the predictive machine learning model may be further trained with classification information, such as with a linguistic measures set that provides information regarding how different words generate different emotional and cognitive responses. Such additional data could be used to further differentiate the predicted effectiveness indicators, such that they do not just show how different components of the representation contribute to overall effectiveness, but how they may contribute to particular emotional or cognitive responses.

In a next step S20 a user indication of a desired property for a representation is input. This desired property should be a quantifiable property and may be a performance metric such as a click-through rate, a number of downloads of an App or a number of website accesses or a number of applications to join a club etc.

At step S30 the method uses the trained machine learning model to provide predictive effectiveness scores that indicate effectiveness relative to the input user desired property for all or a subset of the data set of representations.

At step S40 components of the user data set of representations are analysed to determine a contribution to the predicted effectiveness scores arising from different components of the representations.

At step S50 at least some of the set of representations, the predicted effectiveness scores and the component contributions are input to a generative machine learning model and are used in the generation of a candidate set of representations.

These candidate representations are then fed back to the trained machine learning model at step S60 and this is used to provide effectiveness scores relative to the desired properties for at least a subset of the set of candidate representations.

At step S70 the components of at least some of the candidate set of representations are analysed to determine a contribution to the predicted effectiveness scores that arise from different components of the representations.

At step S80 the most effective candidate representations are output along with an indication of their predicted effectiveness and an indication of the contribution of the different components to the predicted effectiveness.

The contribution of the different components to the effectiveness scores may be indicated in a number of different ways such as by using different colours to highlight different components, red perhaps indicating a lower scoring component while green may be used to indicate a higher score component. In some cases, there may be an additional step of outputting proposed alternatives to certain lower scoring components, and there may then be a further step of the user selecting which components to change for the alternatives that are predicted as higher scoring components. In this way a further amended representation may be generated.

Where the predictive machine learning model has been trained with classification information such as linguistic measures, then the output may also indicate the contribution of different words to different emotional or cognitive responses.

The user may then select one or more representations that are predicted to be effective and the user may then disseminate these representations to a group of users via the Internet.

The method of FIG. 3 is a method that may be performed by different entities in different locations to provide the generated effective representations and indications of their effectiveness.

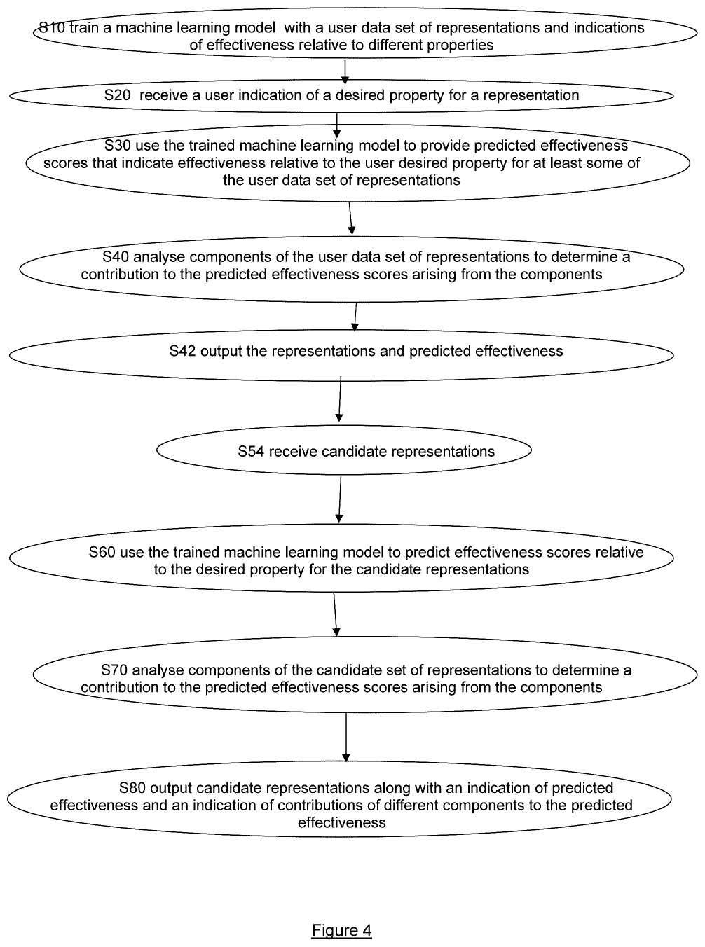

FIG. 4 shows a flow diagram illustrating steps performed in a method to provide an indication of predicted effectiveness of different representations and of different components of the representations. This method may be performed on a server remote from a user and may form a portion of the method disclosed in FIG. 3.

In a first step S10 a predictive machine learning model or algorithm is trained with a user data set of representations and indications of the effectiveness of these representations relative to different properties. This training data may be a set of representations in the field of interest, along with quantitative indications of user engagement for example.

In some cases the predictive machine leaning model may be further trained with classification information, such as with a linguistic measures data set that provides information regarding how different words generate different emotional and cognitive responses. Such additional data could be used to further differentiate the effectiveness indicators not just to indicate how different components of the representation contribute to overall effectiveness, but how they may contribute to particular emotional or cognitive responses.

In a next step S20 an indication of a desired property for a representation is received. This may be received from a user of the model. This desired property should be a quantifiable property perhaps and may be a performance metrics indicative of user engagement such as a click-through rate, a number of downloads of an App or a number of website accesses or a number of applications to join a club etc.

At step S30 the method uses the trained machine learning model to provide predictive effectiveness scores that indicate effectiveness relative to the desired property for all or a subset of the data set of representations.

At step S40 components of the user data set of representations are analysed to determine a contribution to the predicted effectiveness scores arising from different components of the representations. Where the classification data has been used then the effectiveness scores may also indicate how they relate to the different classes or types of cognitive or emotional reaction.

At step S42 the set of representations and the predicted effectiveness scores and the component contributions are output. This may be to a user using the model.

At step S54 candidate representations are received from a user. These may have been generated by generative AI using the set of representations and predicted effectiveness scores output by the trained predictive model and analysing circuitry. These are input to the trained machine learning model at step S60 and this is used to provide effectiveness scores relative to the desired properties for at least a subset of the set of candidate representations.

At step S70 the components of at least some of the candidate set of representations are analysed to determine a contribution to the predicted effectiveness scores that arise from different components of the representations.

Then at step S80 the most effective candidate representations are output along with an indication of their predicted effectiveness and an indication of the contribution of the different components to the predicted effectiveness. Where the trained predictive model was trained on classification data such as linguistic measures too then an indication of the contribution of different components to particular classes of emotional or cognitive responses may also be output.

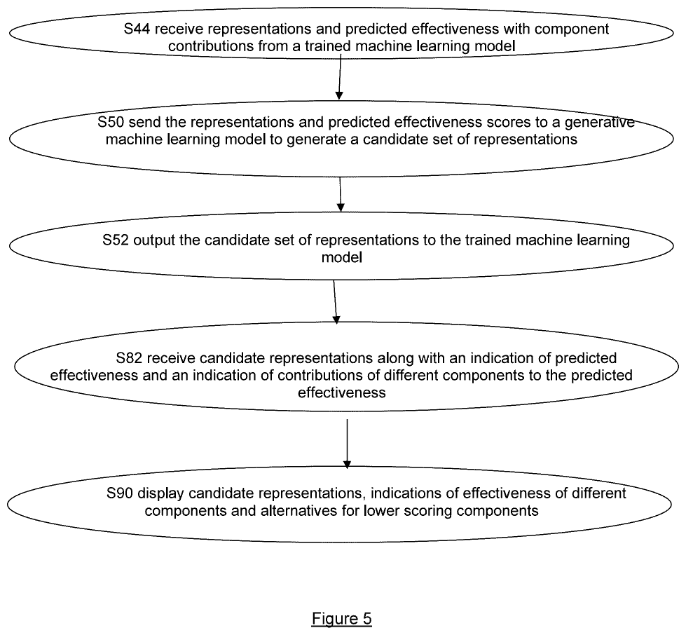

FIG. 5 shows a flow diagram illustrating steps of a method performed by a user generating candidate representations. Again this may be viewed as a subset of the method of FIG. 3 performed by a user using the models to generate representations and an indication of their effectiveness.

At step S44 the user may receive representations and predicted effectiveness and component contributions to that effectiveness from a trained machine learning model. There may be an initial step not shown where the user may indicate to the model a desired property for the representations. At step S50 the user may send the representations and predicted effectiveness scores to a generative machine learning model to generate a candidate set of representations. These are received by the user and then at step S52, the user may output the received candidate set of representations to the trained machine learning model. At step S82 the user may receive candidate representations along with an indication of predicted effectiveness and an indication of contributions of different components to the predicted effectiveness. At step S90 these candidate representations and indications of predicted effectiveness may be displayed to the user. In some embodiments, low scoring components may be highlighted and alternatives suggested. Where this is the case in further steps (not shown) the user may select an alternative and update the representation.

In some cases in addition to the predicted indication of contributions of different components to effectiveness an indication of the components contribution to a particular class of attribute related to a user's type of cognitive or emotional response may also be output, providing further information to a user regarding the basis for the predicted effectiveness.

There may then be a final step where the user selects one or more preferred representations for use in a public information or advertisement campaign for example. By consistently providing representations with improved user engagement the campaigns may output the representations for less time or over fewer sites for the same effect, thereby reducing power and bandwidth costs.

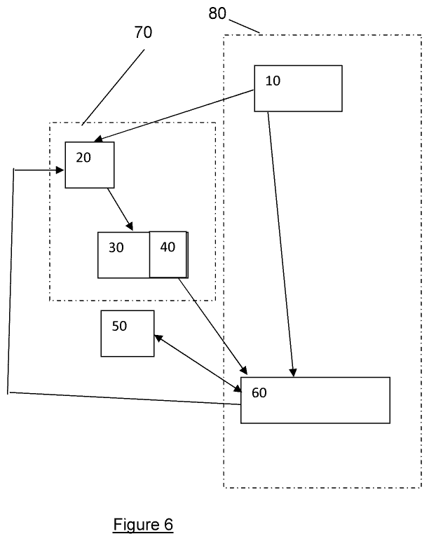

FIG. 6 shows a block diagram schematically illustrating a system according to an embodiment. The system is in three parts that may be located in different locations. There is a portion 80 that is local to a user and comprises an interactive input 10 for the user and display 60 for displaying results to the user.

The user may use the input 10 to input an indication of a desired property for a representation. This is sent to machine learning circuitry 20 located on server 70 and that comprises a predictive machine learning model that has been trained with a data set of representations and associated effectiveness scores of those representations relative to different properties. In some embodiments the machine learning circuitry may also be trained with a data set of linguistic measures indicating how different words contribute to particular emotional or cognitive responses.

The machine learning circuitry 20 provides predicted effectiveness scores for the user indicated property for the representations from the data set. This is sent to analysing circuitry 30 that statistically analyses the data set of representations to determine a contribution to predicted effectiveness scores rising from at least some of the components.

Analysing circuitry 30 uses correlation data generated by machine learning circuitry 40 which is configured to determine the contribution of different components of a representation to particular properties. This may include a linguistic model that will determine for example which words contribute particularly effectively to certain properties. This enables the effectiveness scores generated by the trained circuitry 30 to be put in context such that the different components to the effectiveness scores can be determined and an understanding of the effectiveness score provided.

The output from the analysing circuitry 30 is then sent to a user, who may then transmit the representations and predicted effectiveness scores to generative machine learning circuitry 50 that uses the set of representations and predicted effectiveness scores and component contributions to generate a candidate set of representations that should score highly for the desired property. These are sent to the user who may then transmit them to the trained predictive model 20 and analysing circuitry 30. The output from the analysing circuitry 30 comprises the candidate set of representations, their effectiveness scores and the contributions of components of the representations to these effectiveness scores. These or a subset of these are then output to display 60. In this way candidate representations are both generated and evaluated so that their relevance can be determined by a user.

In some embodiments, the user input 10 is associated with display 60 and a user may interact with the output candidate representations to select lower scoring components within a high scoring representation to be replaced. In some embodiments, the analysing circuitry 30 may additionally output proposed alternatives to lower scoring components for certain representations such that a user may select one of a number of suggested potentially higher scoring replacement components to generate an improve candidate set of representations.

In this way, a user may generate a candidate set of representations in a reduced number of input steps using processing circuitry that is able to in effect filter a large data set of representations to identify the most relevant and to quantify the particular relevance of at least some of the individual components of the representations. The user in this way need only view a reduced set of representations and may interact with the system to improve the generated representations by selecting suggested alternatives. Furthermore, the user will have an idea of why a particular representation is considered to be effective and can then more easily make a judgement call as to the quality of the proposed representations. These selected representations may then be used in preference over other representations in the particular field of application in a way that will increase user engagement thereby decreasing the number of times or time period during which the representation will need to be displayed or made available to generate the same amount of user engagement.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The tern non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

In the claims:

1. A method comprising:
training a machine learning model with a data set of representations and indications of effectiveness relative to different properties;
receiving an indication of at least one desired property;
using said trained machine learning model, to provide predicted effectiveness scores that indicate effectiveness relative to said at least one desired property for at least some of said data set of representations;
analysing components of said at least some of said data set of representations to determine a contribution to said predicted effectiveness scores arising from at least one of said components;
outputting said set of representations, said predicted effectiveness scores and said component contributions;
receiving a candidate set of representations; and using said trained machine learning model to predict effectiveness relative to said at least one desired property for said candidate set of representations;
analysing components of said candidate set of representations to determine a contribution to said predicted effectiveness scores arising from at least one of said components for at least some of said representations in said set of candidate representations; and
outputting at least some of said candidate set of representations along with an indication of predicted effectiveness and of contributions of different components to said predicted effectiveness.

2. The method according to claim 1, wherein said step of analysing said components comprises statistically analysing said components using correlation data that correlates contributions to effectiveness of different components of representations with respect to desired properties.)

3. The method according to claim 2, wherein said analysing step comprises generating said correlation data by inputting a data set of representations and associated effectiveness scores to a machine learning model to train the model to identify a quantitative contribution of different components of the representations to the effectiveness score for different desired properties.

4. The method according to claim 1, wherein said different components comprise at least one of the following: colours, images, words, video or sound.

5. The method according to claim 1, wherein said step of analysing comprises identifying the components that contribute to lower and raise the effectiveness scores for that property.

6. The method according to claim 1, wherein said step of training said machine learning model comprises supplying said machine learning model with a data set providing a quantitative indication of a contribution of different components of a representation to a particular class of attribute, and said step of analysing components of said at least some of said data set of representations comprises determining a quantitative contribution to a particular class of attribute of different components of said representation.

7. The method according to claim 1, wherein said step of outputting at least some of said candidate set of representations comprises outputting said candidate representations with higher predicted effectiveness scores.

8. The method according to claim 1, wherein said step of outputting at least some of said candidate set of representations comprises outputting said candidate representations with indications of components that are lower scoring.

9. The method according to claim 8, wherein said step of outputting at least some of said candidate set of representations comprises outputting proposals for replacement of said lower scoring components with higher scoring components.

10. The method according to claim 1, further comprising:
receiving a set of representations, predicted effectiveness scores and component contributions from a trained machine learning model;
inputting said set of representations to a generative machine learning model;
receiving a candidate set of representations from said generative machine learning model;
outputting at least some of said candidate set of representations to said trained machine learning model; and
receiving said at least some of said candidate set of representations along with an indication of predicted effectiveness and of contributions of different components to said predicted effectiveness from said trained machine learning model; and
displaying at least some of said received candidate set of representations and indications of effectiveness.

11. The method according to claim 10, wherein:
said step of displaying at least some of said received candidate set of representations comprises displaying said candidate representations with higher predicted effectiveness scores; and
said step of displaying at least some of said candidate set of representations comprises displaying said at least some of said candidate representations along with indications indicating components within said representations that are lower scoring components.

12. (canceled)

13. The method according to claim 12, wherein said step of receiving and displaying at least some of said candidate set of representations comprises receiving and displaying proposals for replacement of said lower scoring components with higher scoring components.

14. The method according to claim 13, further comprising a step of receiving a user input indicating at least one preferred replacement higher scoring component; and replacing at least one of said lower scoring components with said selected at least one higher scoring component and displaying an updated candidate representation.

15. The method according to claim 10, comprising an initial step of requesting a user to input a user desired property and outputting said user desired property to said trained machine learning model.

16-17. (cancelled)

18. A system for providing candidate representations and a quantitative indication of the effectiveness of said candidate representations, said system comprising:
an input configured to receive an indication of at least one desired property for a representation;
machine learning circuitry trained with a data set of representations and indications of effectiveness relative to different properties, said machine learning circuitry being configured to provide predicted effectiveness scores that indicate effectiveness relative to said at least one desired property for at least some of said data set of representations;
analysing circuitry configured to analyse at least some of said data set of representations, to determine a contribution to said predicted effectiveness scores arising from at least one of said components;
an output for outputting at least some of said set of representations, said predicted effectiveness scores and said component contributions;
an input for receiving a candidate set of representations and for transmitting said candidate set of representations to said trained machine learning model and then to said analysing circuitry;
wherein said trained machine learning model and analysing circuitry are configured to predict effectiveness relative to said at least one desired property for said candidate set of representations and for components of said candidate set of representations; and
an output for outputting said candidate set of representations processed by said trained machine learning circuitry and said analysing circuitry along with an indication of predicted effectiveness and of contributions of different components to said predicted effectiveness determined by said trained machine learning circuitry and said analysing circuitry.

19. The system according to claim 18, wherein said analysing circuitry is configured to statistically analyse said components using correlation data that correlates contributions to effectiveness of different components of representations with respect to desired properties.

20. The system according to claim 18, wherein said analysing circuitry is configured to identify the components that contribute to lower and raise the effectiveness scores for that property.

21. The system according to claim 18, wherein said machine learning model is trained by supplying said machine learning model with a data set providing a quantitative indication of a contribution of different components of a representation to a particular class of attribute, and said analysing circuitry is configured to analyse components of said at least some of said data set of representations by determining a quantitative contribution to a particular class of attribute of different components of said representation.

22. The system according to claim 18, wherein said output for outputting at least some of said set of representations is configured to output said predicted effectiveness scores and said component contributions is configured to transmit the predicted effectiveness scores and representations to a generative machine learning model to generate said candidate set of representations and associated effectiveness indicators.

23. A system for generating effective representations and providing a quantitative indication of the effectiveness of different portions of said representations, said system comprising:
an input configured to receive a set of representations, predicted effectiveness scores and component contributions from a trained machine learning model; an output configured to output said set of representations to a generative machine learning model;
an input configured to receive a candidate set of representations from said generative machine learning model;
an output configured to output said candidate set of representations to said trained machine learning model;
an input configured to receive said candidate set of representations along with an indication of predicted effectiveness and of contributions of different components to said predicted effectiveness from said trained machine learning model; and
a display configured to display at least some of said candidate set of representations and indications of effectiveness;
wherein said input is configured to receive proposals for replacement of said lower scoring components with higher scoring components; and said display is configured to display said proposals. 24-25. (cancelled)
